(19) United States
(12) Patent Application Publication
(10) Pub. No.: US 2021/0056134 A1
(43) Pub. Date: Feb. 25, 2021

(54) System for Presenting a Collection of Objects for Both in Person and Internet Review

(71) Applicants: Whitmyer IP Group LLC, Stamford, CT (US); Fernando Luis Alvarez Gallery Inc., Redding, CT (US)

(72) Inventors: Wesley W. Whitmyer, JR., Stamford, CT (US); Dean A. Radice, JR., Stamford, CT (US); Fernando Luis Alvarez, Redding, CT (US)

(73) Assignees: Whitmyer IP Group LLC, Stamford, CT (US); Fernando Luis Alvarez Gallery Inc., Redding, CT (US)

(21) Appl. No.: 16/549,152

(22) Filed: Aug. 23, 2019

(51) Int. Cl. G06F 16/58; G06F 16/532; G06F 16/538; G06K 7/14; G06F 16/955

(52) U.S. Cl. CPC G06F 16/5866; G06F 16/532; G06F 16/9566; G06K 7/143; G06F 16/538

(57) ABSTRACT

A system for presenting a collection of objects including a database of images for each of the collection of objects and a computer in data communications with the database. The system also includes a plurality of tags respectively associated with each of the collection of objects and data associated with each of the collection of objects both of which are stored in the database together with the corresponding image. Further, the system has a mosaic created as an array of at least some of the images from each of the collection of objects. The computer includes software that is configured to receive an image selection from an array position of the mosaic or one of the plurality of tags and to retrieve and transmit the corresponding image and data from the database for display.

### TECHNICAL FIELD

The disclosure herein generally relates to identification tags containing a code associated with unique physical objects for in person and internet review. More specifically, this invention relates to QR codes associated with pieces of art represented online by images, mosaics, web pages, and physical and digital QR codes.

### BACKGROUND

Object presentation systems known in the art allow for in person and online presentation of objects. These systems use a code, typically a QR code, to link the physical object to a digital representation. Accompanying the digital representation is more information about the object that can be readily stored and accessed online. This physical and online identification has typically been used for digitally compiling large objects such as houses. This information is typically accessed by potential buyers.

Additionally, known systems have also been used for objects that have extensive information that would be difficult to store or access physically such as custom parts. This information is typically accessed by someone coming to service the part or an owner looking for a replacement.

Known systems distinctly lack the ability to contain the collection of objects within a single interior space. Objects in know systems typically are too large to be encompassed in an interior space or are not of the type to be housed together. Known systems also lack a mosaic media display of images of the objects. Such a display allows users to view a plurality of objects in a compressed manner, compare side by side different objects, and get an overall sense of the types of objects catalogued by the system.

Another known system is the STQRY mobile storytelling platform. The STQRY platform serves as a travel guide to enhance visitor experience, and more specifically, visitors use the STQRY mobile app to search for arts and cultural attractions in an area. The STQRY app can then provide turn-by-turn directions to the attractions and provide content relevant to the user's location. For example, a user can

However, the STQRY platform does not utilize tags, such as QR codes, associated with particular objects (e.g., artwork) to deliver or transmit information and/or content relating to the particular object (e.g., title of artwork, date created, name of artist, etc.). Instead, the STQRY platform uses a generic tag that directs people to the application store on their mobile device in order to download the native mobile STQRY app. The generic tag is not specifically tied to an object such that information and/or content about the object is automatically transmitted to the user through a web application (i.e., web browser) upon scanning/reading the QR code. Also, the native mobile STQRY app focuses more on providing information about the venue (e.g., museum) related to the art or cultural attraction, including contact information (e.g., phone, address), hours of operation, visitor services, and basic information concerning exhibits. Further, the STQRY platform does not create and display mosaics comprising an array of images from a collection of objects, wherein the mosaic presents information about a particular object and directs the user to more detailed information and content about the particular object upon user selection. Moreover, the STQRY platform does not provide additional information relating to a particular object, such as public feedback and comments on the particular object or information on other objects (e.g., artwork) made by the same artist of the particular object.

The system disclosed herein overcomes the above drawbacks and disadvantages of known systems. The system of the present invention is related to objects contained in an interior space. The system also provides for a mosaic media display of images of the objects. The system of the present invention utilizes tags associated with each object (e.g., artwork) to deliver and transmit information and/or content relating to the respective object (e.g., title of artwork, date created, name of artist, etc.), and more specifically, automatically transmits information and/or content about an object to a user's device through a web application (i.e., web browser) upon scanning/reading a tag associated with that particular object.

### SUMMARY

Disclosed herein is one aspect of a system for presenting a collection of objects comprising a database of images for each of the collection of objects and a computer in data communications with the database. The system also has a plurality of tags respectively associated with each of the collection of objects and data associated with each of the collection of objects both of which are stored in the database together with the corresponding image. Further, the system has a mosaic created as an array of at least some of the images from each of the collection of objects. The computer includes software that is configured to receive an image selection from an array position of the mosaic or one of the plurality of tags and to retrieve and transmit the corresponding image and data from the database for display.

In one aspect, the mosaic is random each time it is created. More specifically, the images that make up the array of the mosaic are in a substantially random order each time the mosaic is created.

In one aspect, the mosaic is modified by adding images of each of the collection of objects. As the mosaic is displayed, more images of the collection of objects extend the array of the mosaic.

In one aspect, images of the mosaic are different from other images of the mosaic.

In one aspect, modification of the mosaic stops when all images of the collection of objects are included in the mosaic.

In one aspect, the images of the mosaic adjust to display the title and creator of the object represented by the image in response to a selector (e.g. cursor, finger, stylus, etc.), being positioned over the image.

In one aspect, the computer creates the mosaic.

Also disclosed is one aspect of a system for presenting a collection of objects comprising a database of images for each of the collection of objects and a computer in data communications with the database. The system also has a plurality of tags respectively associated with each of the collection of objects and data associated with each of the collection of objects both of which are stored in the database together with the corresponding image. The data represents other objects displayed with each one of the collection of objects. The computer includes software that is configured to receive at least one of the images from the collection of objects for display, receive an image selection of one of the transmitted images or one of the plurality of tags, and retrieve and transmit the corresponding image and data from the database for display.

In one aspect, the objects from the collection and the other objects are displayed at the same time.

In one aspect, the objects from the collection are contained in the same interior space as at least one other object from the collection of objects.

In one aspect, each tag includes a QR code.

Also disclosed is one aspect of a system for presenting a collection of objects comprising a database of images for each of the collection of objects and a computer in data communications with the database. The system also has a QR code respectively associated with each of the collection of objects and data associated with each of the collection of objects both of which are stored on the database together with the corresponding image. The computer includes software configured to transmit at least one of the images from the collection of objects for display, receive an image selection of one of the transmitted images or one of the QR codes, and retrieve and transmit the corresponding image and data from the database for display.

In one aspect, the collection of objects is contained in a single interior space.

In one aspect, the QR code is mounted separately from the object it is associated with.

In one aspect, the QR code is a web address.

Also disclosed is one aspect of a system for presenting a collection of objects comprising a database of images for each of the collection of objects and a computer in data communications with the database. The system also has a plurality of tags respectively associated with each of the collection of objects and data associated with each of the collection of objects both of which are stored on the database together with the corresponding image. The data represents feedback on each of said collection of objects. Further, the system has a mosaic created as an array of at least some of the images from each of the collection of objects. The computer includes software configured to receive an image selection from an array position of the mosaic or one of the plurality of tags and to retrieve and transmit the corresponding image and data from the database for display.

In one aspect, feedback includes a viewer quote.

In one aspect, the viewer quote is generated by a viewer who repeatedly interacts with the object. Repeatedly can mean someone who views the object daily, weekly, monthly, or some number of times such that the viewer is familiar with the object's physical impression.

In one aspect, multiple viewer quotes are associated with each of said collection of objects.

In one aspect, one viewer quote is chosen at random to be transmitted to a display.

### BRIEF DESCRIPTION OF THE DRAWINGS

FIG. 1 is a schematic diagram depicting all system components and flow of data.

FIG. 2 is a flow chart depicting the process of data retrieval from an identifier code.

FIG. 3 is a flow chart depicting the process of data retrieval from an image displayed online.

FIG. 4 illustrates an aspect of how the objects of the collection and the codes associated with them are displayed.

### DETAILED DESCRIPTION

The present teachings are described more fully hereinafter with reference to the accompanying drawings, in which the present objects are shown. The following description is presented for illustrative purposes only and the present teachings should not be limited to these embodiments. Any computer configuration and architecture satisfying the speed and interface requirements herein described may be suitable for implementing the system and method of the present objects.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A system for in person and internet review of objects is disclosed herein.

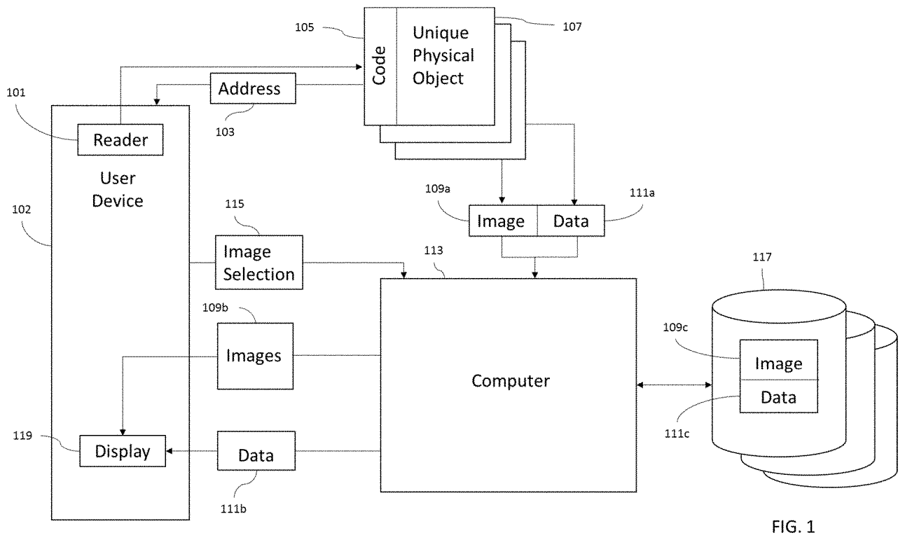

Referring to FIG. 1, the system can include a user device 102 having a user reader 101 and a user display 119, an object 107, a code 105 associated with the object 107, a computer 113, a database 117, and a communications network. An image 109a of the object 107 and data 111a of the object 107 are input into the computer 113. The computer 113 stores the image 109a as image 109c and the data 111a as data 111c on the database 117.

A code 105 is associated with each of the collection of objects. The user reader 101 scans the code 105 for a particular object and returns an address 103 to the user device 102. The user device 102 receives inputs selecting the address and sends the selection 115 to the computer 113. The computer 113 retrieves image 109c and data 111c from the database 117 corresponding to the object 107 associated with the selected address 103 and sends them as images 109b and data 111b to a user display 119.

In one object the computer 113 retrieves the image 109c from the database 117 of more than one object 107. The computer 113, another computer or an outside user arranges the retrieved images into an array and sends the images 121 to the user display 119. The user device 102 makes an image selection 115 from the images 121, wherein the selection is sent to the computer 113. The computer 113 retrieves image 109c and data 111c from the database 117 corresponding to the object 107 associated with the image of the image selection 115 and sends them as images 109b and data 111b to a user display 119.

The computer 113 can be a computer server, a personal computer, desktop computer, laptop, tablet, cell phone, or any other device capable of sending and receiving images and data over a communications network.

The database 117 can be a memory chip, internal hard drive, external hard drive, cloud-based storage, or any other means of digitally storing data that can communicate with the computer.

The communications network can be the internet, a local area network (LAN), wide area network (WAN), wireless communication network, any combination of the preceding, or any other connection between computing devices that is capable of transmitting a signal from one device to another in order to facilitate data transfer.

The code 105 can be a QR code, a barcode, a Microsoft High Capacity Color Barcode, an Aztec code, a SPARQ code, a MaxiCode, a DataMatrix, an RFID tag, an NFC tag, and/or any other one, two, or three-dimensional code capable of storing data.

The user reader 101 can be a camera, QR code scanner, barcode scanner, or any reader capable of extracting data from the code 105. In other aspects, the user reader 101 can be a generic reader capable of recognizing and detecting various types of codes or be a reader for recognizing a specific type of code.

The user display 119 can be a computer monitor, smart phone screen, or any display capable of displaying text and images.

The object 107 can be a painting, a sculpture, a print, a photograph, a drawing, a mixed media display, an architectural installation, or any other piece of art. The object 107 can be a physical object. The object 107 can be a unique physical object.

The data 111a-c can be information about the object including but not limited to, a title of the object, the name of the creator of the object, information about the creator, where it was made, when was it made, why was it made, a description of the piece, other objects made by the same creator, other objects it is similar to, what it is made out of, and its dimensions. The data 111a-c can also include contextual data about the object including but not limited to other objects displayed with each of the collection of objects and feedback about the object. The feedback can be statements about the object from people who regularly view the object.

The image 109a-c can be an image of the object, an image of the creator of the object, an image of a person whose feedback is displayed with the object, or an image of other objects displayed with the object. The image 109b can also be a collection, assortment, mosaic, array or other display of at least one of an image of the object, an image of the creator of the object, an image of a user whose feedback is displayed with the object, or an image of other objects displayed with the object.

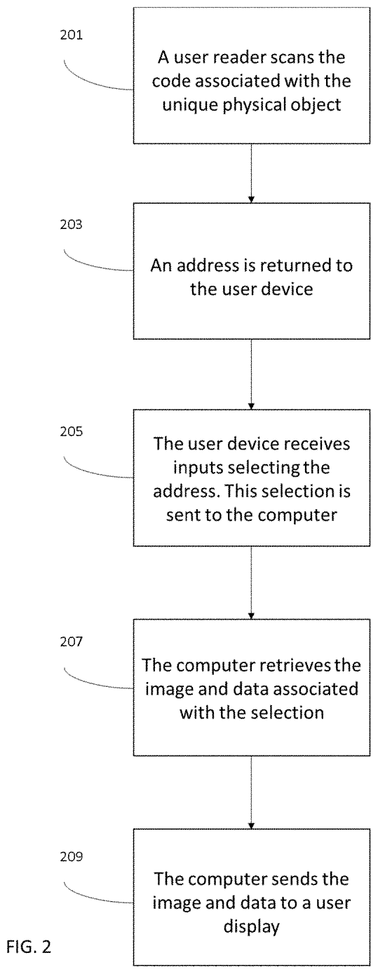

FIG. 2 is a flow chart showing the process of retrieval of data from a code as exemplified in FIG. 1. Beginning in block 201 the user reader detects or scans the code in order to retrieve information stored within the code. The information of the code is specific to the object it is associated with.

In block 203 the address can be a universal resource locator (URL) specifying a hypertext transfer protocol (HTTP) domain which is sent to the user display. Through the user device the address can be selected or saved for viewing at a later time.

In block 205 once the address is selected, either at the time of scanning or at a later time, the selection is sent to the computer over the communication network.

In block 207 the computer in communication with the database retrieves the image and data associated with the received selection from the user device. There can be multiple images and data associated with the address.

In block 209 the retrieved images and data are transmitted to a display for the user to view. This display can be a smart phone screen, a computer monitor, or another digital display capable of receiving the transmitted images and data.

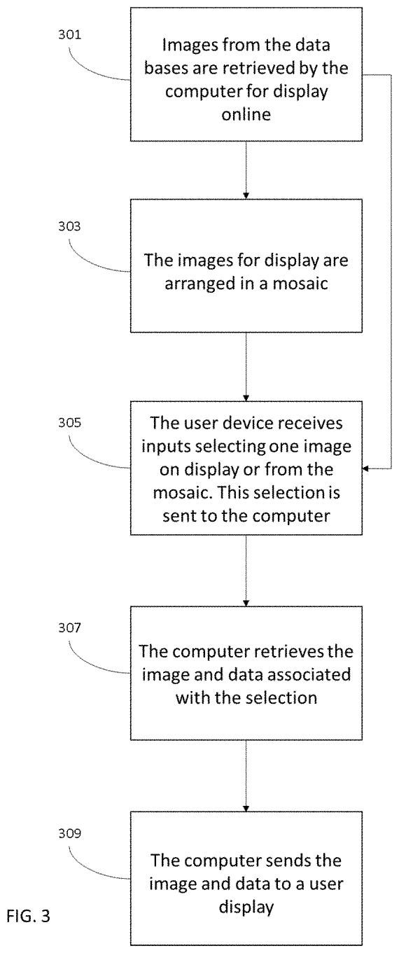

FIG. 3 is a flow chart depicting the process of data retrieval from an image displayed online as exemplified in FIG. 1. In block 301 the computer retrieves at least one image of the objects of the collection of objects from the database for display. The computer can continue to retrieve images from the database as needed for display.

In one aspect, the images displayed are images of related works displayed on the web page for an object from the collection of objects. Related works can be from the same artists, same time period, same art style, or other quality that relates the works to one another.

In block 303 the retrieved images are arranged in a mosaic. The mosaic can be prearranged, or it can be actively created as it is viewed. The mosaic of images is then displayed.

In one aspect the mosaic that is created has four columns of equal width. In other aspects, the mosaic can have any number of columns (e.g. 2, 3, 5, 6, etc.) of equal or varying width. The computer populates the columns with images from the database. As the mosaic is viewed, the computer adds more images to extend the mosaic. The computer can stop once all images of each of the collection of objects has been included in the mosaic or it can repeat images and continue adding images.

In block 305 the user device receives inputs selecting one of the images on display. The user device can select from the images displayed as described in block 301 or from the mosaic created as described in block 303. The selection is sent to the computer.

In block 307 the computer in communication with the database retrieves the image and data associated with the received selection from the user device. There can be multiple images and data associated with the selection.

In block 309 the retrieved images and data are transmitted to a display for the user to view. This display can be a smart phone screen, a computer monitor, or another digital display capable of receiving the transmitted images and data.

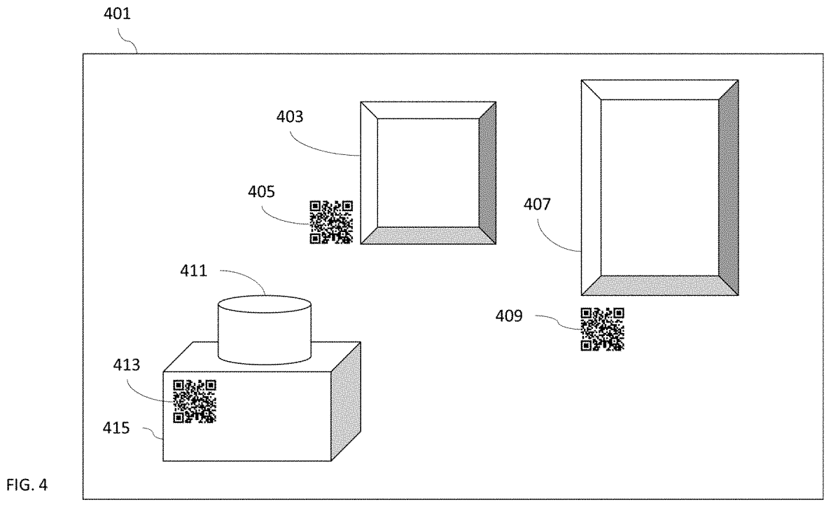

FIG. 4 depicts an aspect of how objects within the collection of objects and the codes associated with them are displayed in person. The objects 403, 407, 411 and codes 405, 409, 413 are displayed in an interior space 401.

The objects can be of different mediums and art styles. For example, objects 403 and 407 are mounted on a wall and can be a painting, a canvas, a drawing, a print, a photograph or any other generally planar object mountable on a wall, whereas object 411 is placed on a surface/table/pedestal 415 and can be a sculpture or any other three-dimensional object placeable on a surface.

The codes 405, 409, 413 are displayed next to and mounted separately from the objects 403, 407, 411, with which they are associated. Code 405 is associated with object 403. Code 409 is associated with object 407. Code 413 is associated with object 411. The codes when read will return an address specific to the object. Code 405 is mounted on the same surface as object 403. Code 409 is mounted on the same surface as object 407. Code 413 is mounted to surface/table/pedestal 415 and object 411 is on top of surface/table/pedestal 415.

The codes 405, 409, 413 displayed in this object are QR codes but the codes 405, 409, 413 can be a barcode, a Microsoft High Capacity Color Barcode, an Aztec code, a SPARQ code, a MaxiCode, a DataMatrix, an RFID tag, an NFC tag, or any other one, two, or three-dimensional code capable of storing data.

While the present teachings have been described above in terms of specific embodiments, it is to be understood that they are not limited to these disclosed embodiments but can include any combination of the features of the described embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

1. A system presenting a collection of objects for both in person and Internet review, comprising:
a database of images for each of the collection of objects;
a computer in data communication with said database;
a plurality of tags respectively associated with each of the collection of objects and stored on said database together with the corresponding images;
data associated with each of the collection of objects stored on said database together with the corresponding images;
a mosaic created as an array of at least some of the images from each of the collection of objects; and
software executing on said computer for receiving an image selection from an array position of said mosaic or one of the plurality of tags, and for retrieving and transmitting the corresponding image and data from said database for display.

2. The system of claim 1, wherein said array of images is arranged in a substantially random order each time the mosaic is created.

3. The system of claim 2, wherein said mosaic is modified such that further images from each of the collection of objects are added to said array as the mosaic is displayed.

4. The system of claim 3, wherein said images of the mosaic are different from each other.

5. The system of claim 4, wherein modification of the mosaic stops when all images of each of the collection of objects are included in the mosaic.

6. The system of claim 1, wherein one of said images of the mosaic adjust to display title and a creator of the object represented by said one image in response to a selector being positioned over said one image.

7. The system of claim 1 wherein said computer creates said mosaic.

8. A system presenting a collection of objects for both in person and Internet review, comprising:
a database of images for each of the collection of objects;
a computer in data communication with said database;
a plurality of tags respectively associated with each of the collection of objects and stored on said database together with the corresponding images;
data representing other objects displayed with each one of said collection of objects;
software executing on said computer for transmitting at least one of the images from the collection of objects for display, and for receiving an image selection of said transmitted images or one of the plurality of tags, and for retrieving and transmitting the corresponding image and data from said database for display.

9. The system of claim 8, wherein multiple objects from said collection of objects are on display and viewable at the same time.

10. The system of claim 9, wherein objects from said collection of objects are contained in the same interior space as at least one other object from said collection of objects.

11. The system of claim 8, wherein each tag includes a QR code.

12. A system presenting a collection of objects for both in person and Internet review, comprising:
a database of images for each of the collection of objects;
a computer in data communication with said database;
a QR code respectively associated with each of the collection of objects and stored on said database together with the corresponding images;
data associated with each of the collection of objects stored on said database together with the corresponding images;
software executing on said computer for transmitting at least one of the images from the collection of objects for display, and for receiving an image selection of said transmitted images, and for retrieving and transmitting the corresponding image and data from said database for display; and
software executing on said computer for receiving one of the QR codes, and for retrieving and transmitting the corresponding image and data from said database for display.

13. The system of claim 12, wherein the collection of objects is contained in a single interior space.

14. The system of claim 12, wherein the QR code is mounted separately from the object with which the QR code is associated.

15. The system of claim 14, wherein the QR code is a web address.

16. A system presenting a collection of objects for both in person and Internet review, comprising:
a database of images for each of the collection of objects;
a computer in data communication with said database;
a plurality of tags respectively associated with each of the collection of objects and stored on said database together with the corresponding images;
data representing feedback on each of said collection of objects;
a mosaic created as an array of at least some of the images from each of the collection of objects; and
software executing on said computer for receiving an image selection from an array position of said mosaic or one of the plurality of tags, and for retrieving and transmitting the corresponding image and data from said database for display.

17. The system of claim 16, wherein said feedback includes a viewer quote.

18. The system of claim 17, wherein said viewer quote is generated by a viewer who repeatedly interacts with the object.

19. The system of claim 17, wherein multiple viewer quotes are associated with each of said collection of objects.

20. The system of claim 19, wherein one viewer quote is chosen at random to be transmitted to a display.
